(19) United States
(12) Patent Application Publication
(10) Pub. No.: US 2021/0325416 A1
(43) Pub. Date: Oct. 21, 2021

(54) VIAL GRABBER INSPECTION APPARATUS

(71) Applicants: Mitchell Olin Setzer, SR., Lenoir, NC (US); Mitchell Olin Setzer, JR., Lenoir, NC (US)

(72) Inventors: Mitchell Olin Setzer, SR., Lenoir, NC (US); Mitchell Olin Setzer, JR., Lenoir, NC (US)

(21) Appl. No.: 17/228,620

(22) Filed: Apr. 12, 2021

Related U.S. Application Data
(60) Provisional application No. 63/008,698, filed on Apr. 11, 2020.

(51) Int. Cl. G01N 35/10; G01N 35/00; B01L 9/06

(52) U.S. Cl. CPC G01N 35/1081; G01N 35/00871; B01L 2200/18; B01L 2300/0663; B01L 9/06

(57) ABSTRACT

The present invention generally involves an apparatus and method for grabbing a plurality of vials from a container. In particular embodiments, the present invention may provide a reliable apparatus that a vial inspector may use to pick up a plurality of vials from a container of vials so that the vials can be inspected wherein the apparatus tends to standardize inspection output across a variety of users making the task more productive and production goals easier to establish.

### PRIORITY CLAIM

This application claims priority to U.S. patent application 63/008,698, filed on 11 Apr. 2020, and incorporates such an application by this reference for all that it discloses for all purposes.

### FIELD OF THE INVENTION

The present invention generally involves an apparatus and method for grabbing a plurality of vials from a container. In particular embodiments, the present invention provides a reliable apparatus that a vial inspector may use to pick up a plurality of vials from a container of vials for inspection wherein the apparatus tends to standardize inspection output across a variety of users.

### BACKGROUND OF THE INVENTION

A vial is an essential primary packaging component for pharmaceutical drugs. Many manufactured medications, highly viscous or low-dosage drug formulations, or a series of oncologic and ophthalmologic medications place high demands on primary packaging like vails. Further, many of the medicines packaged in vials are intended for parenteral administration (e.g., injections). Products intended for parenteral administration generally require visual inspection to verify compliance with completeness and clarity and the absence of particulate matter. Test Standards for the inspection of solutions contained in vials have been developed to verify compliance with minimum quality standards related to visible particulates. Examples of such particulate matter include fibers, glass, metal, elastomeric materials, and precipitates.

Some inspection procedures require manual human implementation. Such standards may require the inspected units to be free of visible particulates when examined without magnification against various backgrounds such as a black background and a white background. Illumination at the inspection point is generally maintained between a predefined illumines range. The units under inspection are then gently swirled and/or inverted, ensuring that no air bubbles are produced and inspected for a predefined amount of time against each predefined background (i.e., black, white, other). The inspection results (such as the presence of any particles) are then recorded as required and any necessary action taken.

Prior art methods for manual inspection of vials, as described above, involve placing a container of vials in front of an inspector. The inspectors pick up as many vials as possible (usually three to five) between their fingers and palm, using one hand, and gently turns the vials upside down with a swirl motion in front of a first background to examine the vials and vial contents. The vials are then presented horizontally, and each vial is twisted the inspect the quality of the caps. The inspectors repeat the swirl motion and inversion steps against the other background.

One problem with the above method is that inspectors have a range of hand sizes with different levels of dexterity. Such variations give some inspectors an advantage and thereby complicating the prediction of production and setting production requirements. Further, the method of picking up vials with just the hand can vary from inspector to inspector, which can cause variations in the inspection process, affecting the consistency of the results between inspectors. Notably, whatever an inspection process happens to be for any item, one important criterion is consistency.

Therefore, the need exists for an apparatus and method for picking vials from a container of vials. Embodiments of the present invention provide an ergonomic, reliable apparatus and method for addressing the above-identified disadvantages.

### BRIEF DESCRIPTION OF THE INVENTION

Aspects and advantages of the invention are set forth below in the following description, or may be obvious from the description, or may be learned through practice of the invention.

One embodiment of the present invention is a handheld vial grabber apparatus for grabbing vials from a box of vials. The apparatus comprises a base having a grabber portion and a handle portion. The grabber portion has a grabber portion top surface and an opposing grabber portion bottom surface that extend away from the handle portion to a grabber point. Similarly, the handle portion extends away from the grabber portion but at a predefined handle angle to a handle point. A plurality of vial ports is defined at the grabber point, where each vial port is configured to receive at least part of a vial (such as the neck). A retainer defining a plurality of vial latches may be movably associated with the grabber portion. The retainer is disposed adjacent to one of the grabber surfaces so that the plurality of vial latches are adjacent to the plurality of vial ports. An actuator may be mechanically associated with the retainer to allow a user to move the retainer between an engaged position (to secure the vials in the vial ports) or a disengaged position (to allow vial removal from the vial ports). The vial grabber apparatus may be further configured with an electronic module programmed to assist a person using the vial grabber apparatus in performing a testing procedure and/or documenting test results.

For one alternative embodiment, the handheld vial grabber apparatus comprises a base means for providing a handle at a first end and a grabber point at a second end. A plurality of vial ports is defined by the base means at the grabber point. A retainer means may be movably associated with the base means and configured for engaging and retaining vials in the vial ports when placed in an engaged position and disengaging from the vials when placed in a disengaged position. An actuator means may be mechanically associated with the retainer means and configured for allowing a user to transition the retainer means between the engaged position and the disengaged position.

Additional objects and advantages of the present invention are set forth in the detailed description herein or will be apparent to those skilled in the art upon reviewing the detailed description. Also, it should be further appreciated that modifications and variations to the specifically illustrated, referenced, and discussed steps or features hereof may be practiced in various uses and embodiments of this invention without departing from the spirit and scope thereof, by virtue of the present reference thereto. Such variations may include, but are not limited to, the substitution of equivalent steps, referenced or discussed, and the functional, operational, or positional reversal of various features, steps, parts, or the like. Additionally, it is to be understood that different embodiments, as well as different presently preferred embodiments, of this invention, may include various combinations or configurations of presently disclosed features or elements, or their equivalents (including combinations of features or parts or configurations thereof not expressly shown in the figures or stated in the detailed description).

Those of ordinary skill in the art will better appreciate the features and aspects of such embodiments, and others, upon review of the remainder of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is an exploded perspective view of an apparatus according to one embodiment of the present invention;

FIG. 2 is an elevated top perspective view of the apparatus shown in FIG. 1 retaining a plurality of vials;

FIG. 3 is an elevated top perspective view of the apparatus shown in FIG. 1 in an engaged position;

FIG. 4 is an elevated top perspective view of the apparatus shown in FIG. 1 in a disengaged position;

FIG. 5 is a top plan view of the apparatus shown in FIG. 3;

FIG. 6 is a bottom plan view of the apparatus shown in FIG. 3;

FIG. 7 is a front elevational view of the apparatus shown in FIG. 3;

FIG. 8 is a back elevational view of the apparatus shown in FIG. 3;

FIG. 9 is a left elevational view of the apparatus shown in FIG. 3;

FIG. 10 is a right elevational view of the apparatus shown in FIG. 3;

FIG. 11 is a perspective view of one embodiment of a retainer;

FIG. 12 is a front side elevational view of the retainer in FIG. 11;

FIG. 13 is an elevated perspective view for one embodiment of an actuator;

FIG. 14 is a bottom plan view for the actuator in FIG. 13; and

FIG. 15 presents a block diagram representation of one exemplary embodiment of an electronic module.

Repeat use of reference characters throughout the present specification and appended drawings is intended to represent the same or analogous features or elements of the present technology. Various objects, advantages, and features of the invention will become apparent to those skilled in the art from the following discussion taken in conjunction with the drawings.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. Each example is provided by way of explanation of the invention, not limitation of the invention. It will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

For the purposes of this document, two or more items are “mechanically associated” by bringing them together or into a relationship with each other in any number of ways, including: direct or indirect physical “releasable connections” (snaps, screws, Velcro®, bolts, clamps, etc.—generally connections designed to be easily, perhaps frequently, released and reconnected); “hard-connections” (welds, rivets, macular bonds, generally connections that one does not anticipate disconnecting very often if at all—a connection that is generally “broken” to separate); and/or “moveable connections” (rotating, pivoting, oscillating, etc.).

Two or more items are “electrically associated” by bringing them together or into a relationship with each other in any number of ways, including: (a) a direct/indirect or inductive communication connection; and (b) a direct/indirect or inductive power connection. Communication connections can be wired or wireless unless expressly stated otherwise. Additionally, while the drawings may illustrate various electronic components of a system connected by a single line, it will be appreciated that such lines may represent one or more signal paths, power connections, electrical connections, and/or cables as required by the embodiment of interest.

As used herein, the terms “first,” “second,” and “third” may be used interchangeably to distinguish one component from another and are not intended to signify the location or importance of the individual components. The term “axial” refers to a direction parallel to the direction of rotation of an object; the term “radial” refers to a direction extending away from the center of an object or normal to the “axial” direction, and the term “circumferential” refers to a direction extending around the circumference or perimeter of an object.

As used in the claims, the definite article “said” identifies required elements that define the scope of embodiments of the claimed invention, whereas the definite article “the” merely identifies environmental elements that provide context for embodiments of the claimed invention that are not intended to be a limitation of any claim.

In this document, unless otherwise stated, the phrase “at least one of A, B, and C” or “one of A, B, and C” means there is at least one of A, or at least one of B, or at least one of C or any combination thereof. Such does not mean one of A, and one of B, and one of C.

This document contains headers, which are reference points to aid a reader only, and such headers have neither disclosure nor construction value. Headers are not to be used to interpret this document.

The examples used in this written description are directed to an apparatus for picking up vials containing medications intended for parenteral administration (i.e., injections). It should be appreciated, however, that the disclosed technology may be used to pick up vials that contain any substance.

### DESCRIPTION

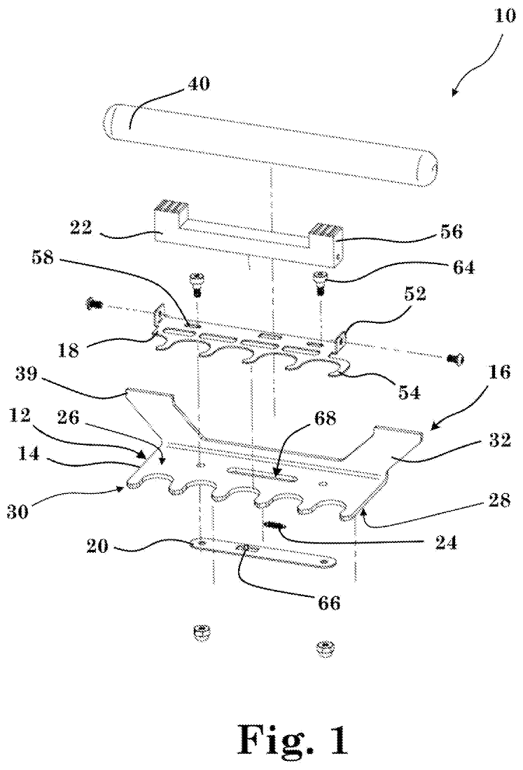

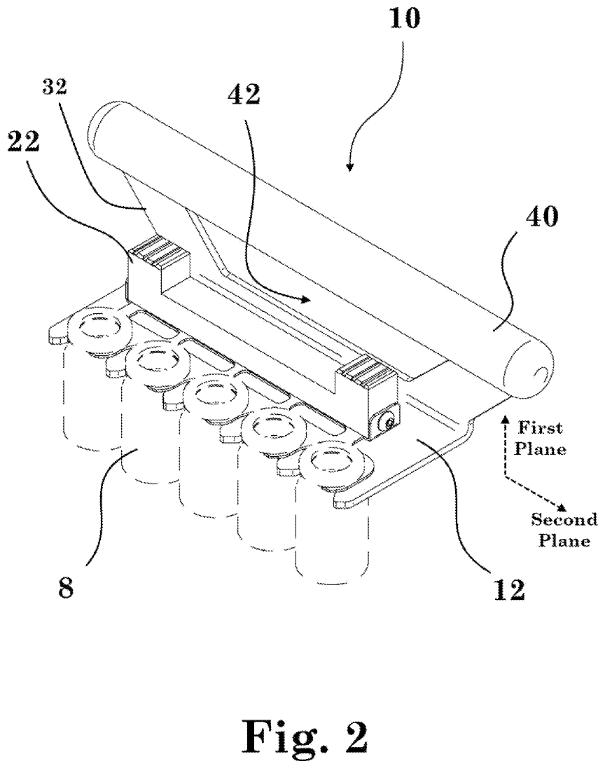

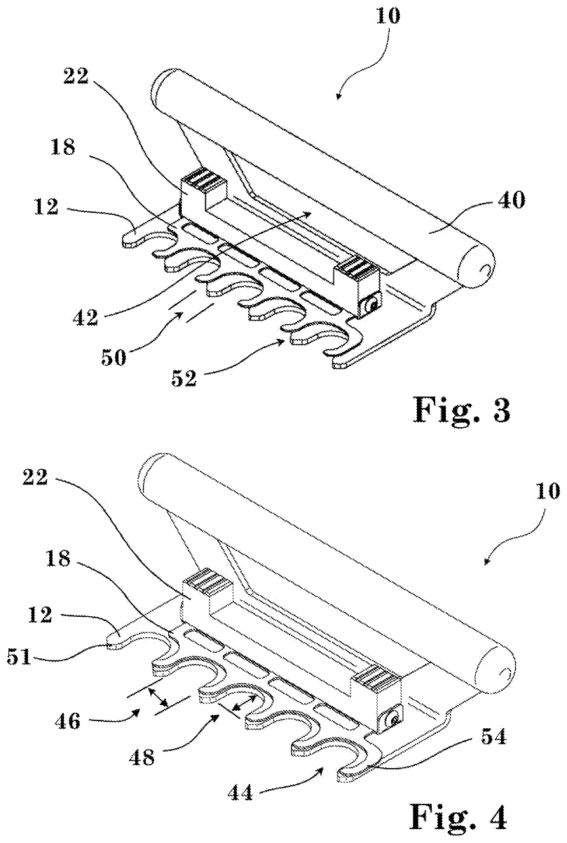

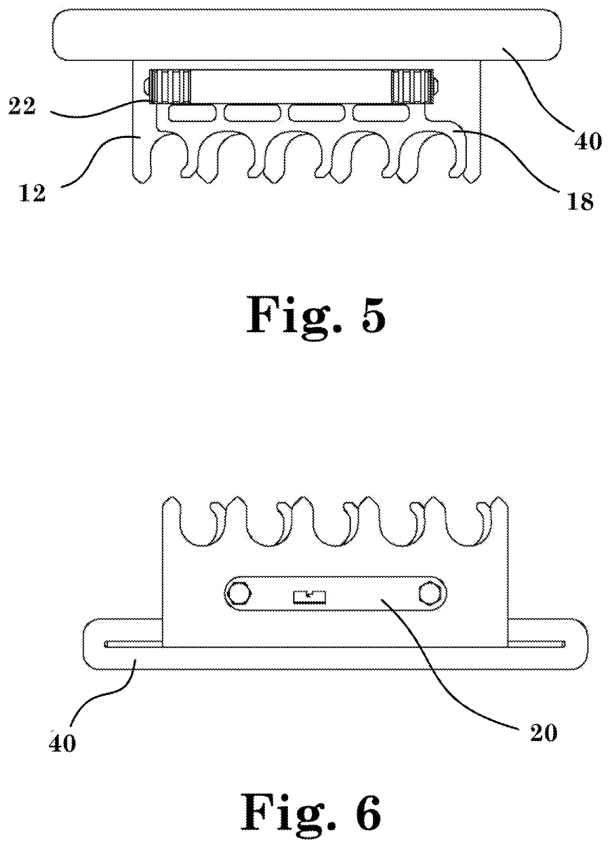

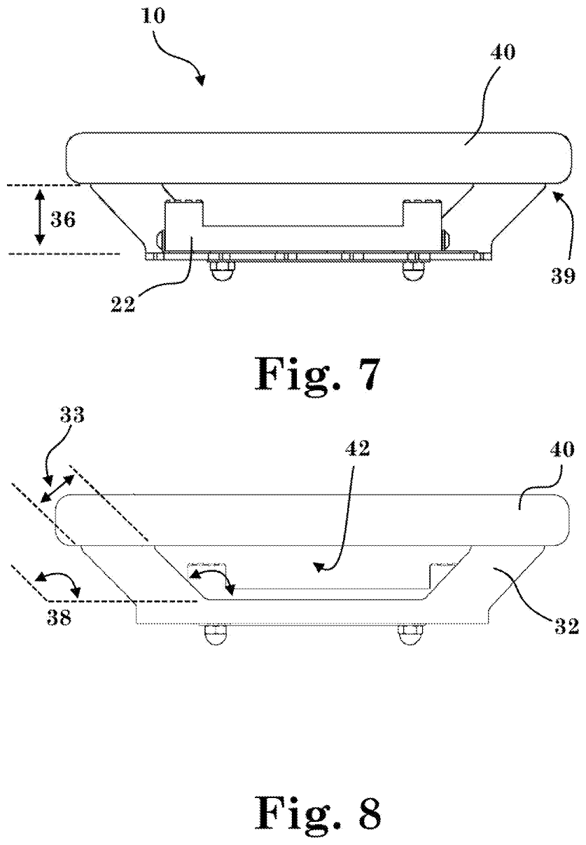

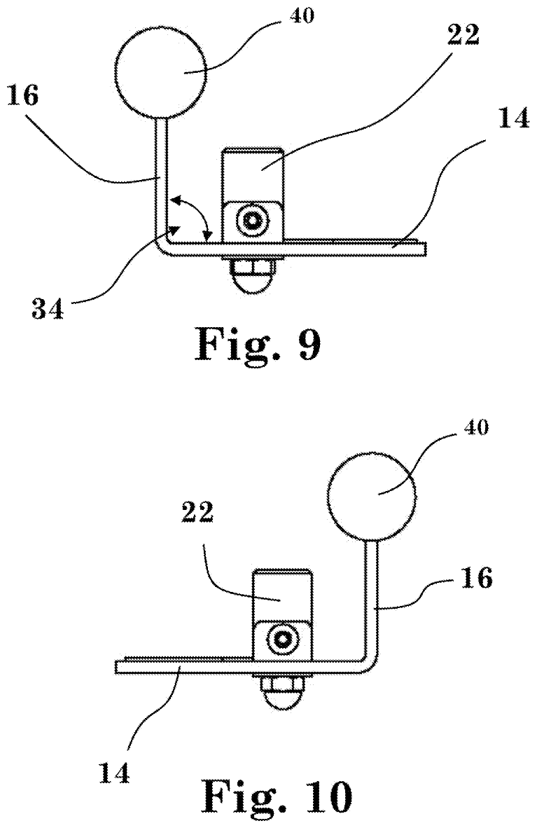

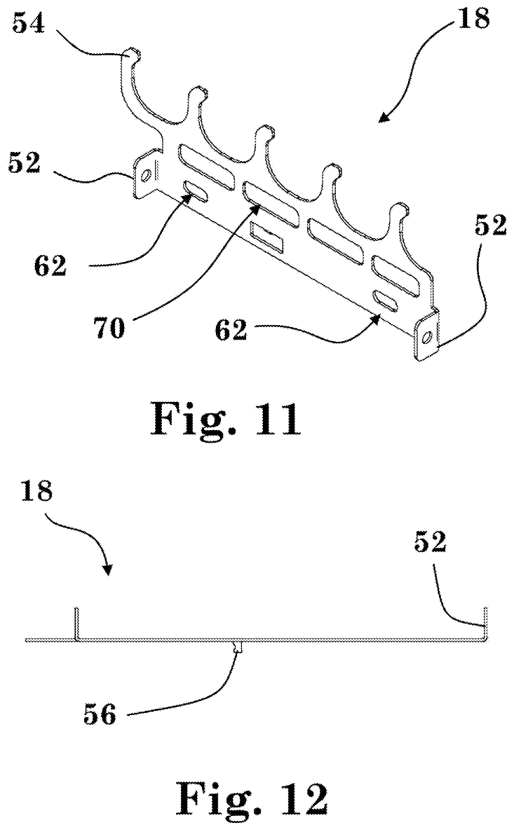

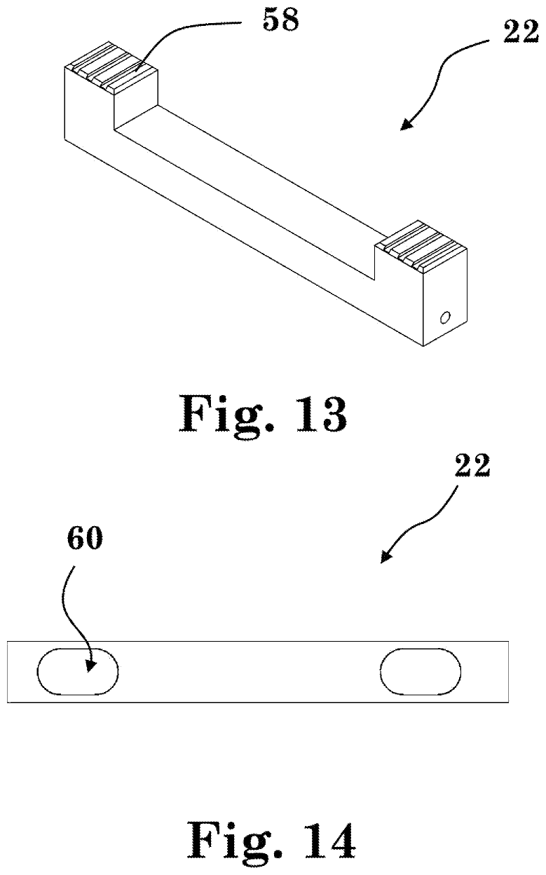

Referring now more particularly to FIG. 1 through FIG. 10, presented is a handheld vial grabber apparatus 10 for grabbing and picking up vials 8. FIG. 1 provides an exploded view of apparatus 10, while FIG. 2 provides a front elevated perspective view of apparatus 10 with the retainer 18 in the engaged position and holding five exemplary vials 8. FIG. 3 shows apparatus 10 with the retainer 18 in an engaged position without vials, and FIG. 4 shows apparatus 10 in a disengaged position. FIG. 5 shows a top plan view of apparatus 10, and FIG. 6 shows a bottom plan view of apparatus 10. FIG. 7 shows a front side elevational view, and FIG. 8 shows a back side elevational view of apparatus 10. FIGS. 9 and 10 show side elevational views of apparatus 10, while FIGS. 11 and 12 present closeup views of an exemplary retainer 18, and FIGS. 13 and 14 present closeup views of an exemplary actuator 22.

Referring now more specifically to FIGS. 1 and 2, for the embodiments described herein, a vial grabber apparatus 10 configured for picking up a plurality of vials 8 is disclosed and may comprise a combination of the components presented in FIG. 1. A base 12 may define a grabber portion 14 and a handle portion 16. A retainer 18 may be movably associated with a surface of the grabber portion 14 by a back plate 20. An actuator 22 may be mechanically associated with the retainer 18, and the actuator 22 may be configured to transition the retainer 18 between an engaged position (FIG. 3) and a disengaged position (FIG. 4). A resilient element 24 may be mechanically associated with the retainer 18 to bias the retainer 18 in one of the engaged position or the disengaged position. In FIG. 3, and the current configuration, the resilient element 24 biases the retainer 18 in the engaged position.

For the current embodiment of the invention, apparatus 10 comprises a base 12 having a grabber portion 14 and a handle portion 16. The grabber portion 14 has a grabber portion top surface 26 and an opposing grabber portion bottom surface 28 defining a plate-type configuration. The handle portion 16 may be integral to the grabber portion 14 and may define opposing surfaces defining a similar thickness as the grabber portion 14, as depicted in the figures. The grabber portion 14 extends away from the handle portion 16 to a grabber point 30. The handle portion 16 may define a plurality of risers 32, with each defining a riser width 33 (FIG. 8), which may or may not be equal. For the current embodiment, there are two risers 32 of equal width. The riser(s) may extend away from the grabber portion 14 at a handle angle 34 (FIG. 9), for a riser length 36 (FIG. 7), and at riser angle 38 (FIG. 8) to a handle point 39. A handle 40 may be defined at handle point 39 as an integral component, or a handle 40 may be mechanically associated with the handle point 39.

For one embodiment, and as best seen in FIG. 1 and FIG. 8, the handle portion 16 defines opposing risers 32 that extend away from the grabber portion 14 at the previously mentioned handle angle 34 along a first plane and a predefined riser angle 38 along a second plane (that is perpendicular to the first plane) to create a riser gap 42 (FIG. 8). The riser angle 38, riser length 36, and the riser width 33 of each riser 32 may be selected to generate a desired riser gap 42 that allows users to extend their fingers through the riser gap 42 and grip the handle 40 so that the actuator 22 can be actuated using a thumb (or finger). Such allows operation of the apparatus 10 with one hand. For some embodiments, the handle portion is adjustable (i.e., at least one of the handle length, handle size, riser gap, etc.).

For the current embodiment, the handle angle is 90 degrees (i.e., the handle portion 16 extends perpendicularly away from the grabber portion 14) and may vary between about 80 degrees and about 180 degrees. Similarly, the riser angles 38 (FIG. 8) are 45 degrees, as depicted in the figures, and may vary between about 25 degrees and about 65 degrees. Here, “about” means plus or minus 10%.

As best seen in FIG. 4, a plurality of vial ports 44 is defined at the grabber point 30. Each of the vial ports 44 defines a vial port width 46 and a vial port depth 48 configured to receive a vial 8 having a predefined size or a predefined range of sizes. For example, many pharmaceutical companies use vials with two standard size variations (for stoppers & caps) of 13 mm and 20 mm, and apparatus 10 may be suitably sized to accommodate such range of vial sizes. A vial port separation distance 50 (FIG. 3) may be selected based on the diameter of the largest vial body of interest. It will be appreciated by one of ordinary skill in the art that the overall width of the apparatus 10 will depend on the number of vial ports 44 and the vial port separation distance 50. For the present embodiment, the vial port tips 51 are angled to aid in the routing of vials into the vial port 44.

Apparatus 10 further comprises a retainer 18 movably associated with the grabber portion 14 of the base 12. The retainer 18 has two opposing generally flat surfaces, as depicted in FIG. 11-12, defining a plate-like configuration and further defining two vertically extending attachment tabs 52 for mechanically associating the actuator 22 to the retainer 18. Here, “vertically extending” simply means the attachment tabs 52 extend away from the main retainer 18 body, and the attachment tabs 52 may extend “vertically” at any suitable angle, such as 90 degrees as depicted in the figures. The retainer 18 defines a plurality of vial latches 54 defining a generally hooked shape configured to retain vials 8 in the vial ports 44 when the actuator 22 is moved the retainer 18 to the engaged position (as depicted in FIG. 2). The retainer 18 may be disposed adjacent to any one of the grabber portion surfaces (26, 28); however, for the current embodiment, the retainer 18 is disposed adjacent to the grabber portion top surface 26 so that the vial latches 54 are adjacent to said grabber ports 44. Thus, for the current configuration, retainer 18 defines a first retainer surface and an opposing second retainer surface where the first retainer surface is disposed adjacent to the grabber portion top surface 26, and the second retainer surface is configured to receive the actuator 22. The actuator 22 may be mechanically associated with the retainer 18 via the attachment tabs 52 using common attachment elements, including screws, bolts, and rivets. Notably, for embodiments comprising a resilient element 24, the retainer 18 further defines a retainer tab 56 configured for receiving one end of a resilient element 24 described in more detail below.

As best seen in FIG. 13 and FIG. 14, for one embodiment, the actuator 22 defines two opposing actuator tabs 58 deposed at opposite ends of the actuator 22. The distance between the actuator 22 and handle 40 may be predefined to allow a user to use apparatus 10 with one hand (either the right or left) by grasping the handle 40 with fingers and moving the actuator 22 with a thumb (or a finger). Actuator slots 60 may be defined by the actuator 22 and may be configured for receiving bottom plate bolts described later. For one alternative configuration, the actuator 22 further houses an electronic module as described later.

As best seen in FIG. 1, and FIG. 6, one embodiment of the invention comprises a bottom plate 20 that may be mechanically associated with any grabber portion surface. For the current configurations, the bottom plate 20 is mechanically associated with grabber portion bottom surface 28, and the retainer 18 is associated with the grabber portion top surface 26. The retainer 18 is movably associated with the bottom plate 20 through retainer slots 62 by bottom plate bolts 64 (FIG. 1). The bottom plate bolts 64 may define a standoff section that allows the retainer 18 to slide across the surface of the grabber portion 14 as allowed by the voids created by the retainer slots 62 and actuator slots 60 which receive the head of bottom plate bolts 64.

For embodiments comprising a resilient element 24, the bottom plate further defines a bottom plate tab 66 configured for receiving one end of the resilient element 24.

The resilient element 24 may be mechanically associated with the retainer 18 to bias the retainer 18 in one of the engaged position or the disengaged position. For the current configuration, a resilient element 24 biases the retainer 18 in the engaged position as depicted in FIG. 3. The resilient element 24 may be of any suitable technology that can automatically return the retainer 18 to the engaged position from the disengaged position. Such a configuration tends to keep the vials secured in the vial ports 44 without additional pressure on the actuator 22. One embodiment of resilient element 24 is a spring defining a resilient element 24 first end and a resilient element 24 second end. The resilient element 24 first end may be associated with a bottom plate tab 66 defined by the bottom plate 20 and the resilient element 24 second end may be associated with a retainer tab 56 defined by the retainer 18, so that resilient element 24 tends to keep/bias the retainer 18 in the engaged position. The resilient element 24 may be of any suitable type, including compression springs, extension springs, torsion springs, Belleville springs, drawbar springs, volute springs, and garter springs. Ideally, the grabber portion 14 defines a grabber portion void 68 configured to receive the resilient element 24, and the resilient element may be suitably sized to fit at least partially inside the grabber portion void 68.

As noted previously, inspection standards for vials 8 often require a set illumination range for the inspection environment. Consequently, for one embodiment of the invention, the base 12 may be at least partially translucent. Similarly, the retainer 18 may be translucent, or it may define a plurality of retainer voids 70 to allow light to shine through the retainer 18 and to and through the base 12 to the vials 8.

From the above, one of ordinary skill in the art will appreciate that one embodiment of the invention can be described as a handheld vial grabber apparatus 10 as comprising a base 12 defining two opposed surfaces that bend to create two portions. A first portion is described as a grabber portion 14 comprising opposing horizontal surfaces (26, 28), and a second portion is described as a handle portion 16 comprising two vertically extending opposing surfaces. The orientation of “horizontal” is simply selected as a reference point to aid in describing the “bend,” creating vertically extending surfaces. Such vertically extending surfaces may extend away from the horizontal surface at any suitable angle. A plurality of vial ports 44 may be defined at a free end 30 of the horizontal surface wherein each of vial ports 44 may be configured to receive at least part of a vial 8. A handle 40 may be defined at the free end 39 of the vertically extending surface. A retainer 18 may be movably associated with the base 12 and may define a plurality of vial latches 54. The vial latches 54 may be configured for engaging and retaining vials 8 within the vial ports 44 when the retainer 18 is moved to an engaged position. The vial latches 54 may release the vials when the retainer 18 is moved to a disengaged position. An actuator 22 may be mechanically associated with the retainer 18 using any suitable technology and may be configured to move the retainer 18 to the engaged position or the disengaged position. The relative position of the handle 40 and the actuator 22 may be selected to allow a user to grasp the handle 40 and actuate the actuator 22 using one hand.

For yet another embodiment of the invention, the handheld vial grabber apparatus 10 includes a base means 12 for providing a handle at a first end 39 and a grabber point 30 at a second end. The function of the base means is to provide the structural body for apparatus 10. The structure for performing such function is the base 12 constructed from any suitable materials such as metals, plastics, and composite materials, including translucent materials. The apparatus 10 further includes a plurality of vial ports 44 defined by the base means 12 at the grabber point 30. The apparatus 10 includes a retainer means movably associated with the base means 12. The function of the retainer means is to engage and retain vials 8 in the vial ports 44, as depicted in FIG. 2, when placed in an engaged position and disengaging from the vials when placed in a disengaged position. The structure for the retainer means is a retainer 18 made from any suitable materials for securing/retaining vials 8 in vial ports 44. For example, clips that automatically open and latch when vials move into vial ports 44 and then are manually retracted to release the vials may be used. For the embodiment disclosed herein, the retainer 18 comprises a plurality of vial latches 54.

The apparatus 10 further includes an actuator means 22 mechanically associated with the retainer means 18. The function of the actuator means 22 is to transition the retainer means between the engaged position and the disengaged position as described above. The structure for performing transitioning the retainer means 18 may be any suitable device that allows a user to actuate the actuator means 22 using a finger or thumb while holding the handle.

The apparatus 10 may further comprise a resilient means 24. The function of the resilient means is to bias the retainer means in one of the engaged position or the disengaged position. The structure for performing the function is any suitable resilient technology, such as the spring technologies described previously.

### Electronic Module

As noted previously, one purpose of vial grabber apparatus 10 relates to the manual inspection of medications packaged in vials intended for parenteral administration (e.g., injections). Such products are generally required to be visually inspected to verify compliance with predefined standards relating to completeness and clarity and the absence of particulate matter. Such test standards may require examining medications in vials for a predefined period of time in front of various backgrounds under predefined lighting conditions. Consequently, some configurations of apparatus 10 may include an electronic module 72 to assist in the inspecting process.

The electronic module 72 may be reprogrammable to change its operation according to different test standards. Alternatively, a plurality of electronic modules may be provided where each module is programmed for a particular test standard. The apparatus 10 would then be fitted with the electronic module for the test standard of interest.

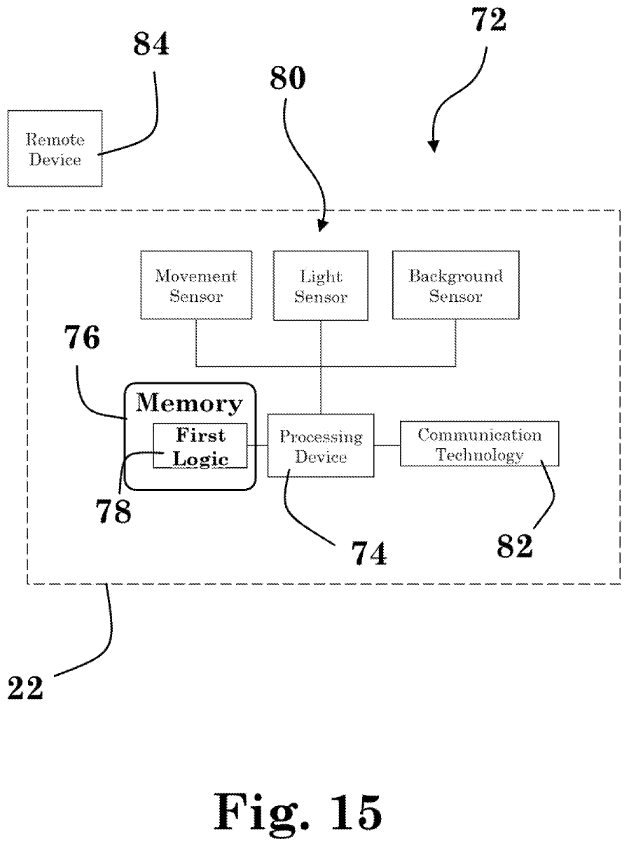

As depicted in FIG. 15, for the current embodiment, the electronic module 72 may be housed by the actuator 22. The electronic module 72 may comprise a processing device 74 associated with a memory 76 for storing a first logic 78. The first logic 78 would ideally comprise at least some of the test parameters needed for a vial inspector to examine a group of vials and verify compliance with a test standard of interest. At least one sensor 80 may be electrically associated with a processing device 74 for detecting a test parameter. For one embodiment, a sensor 80 is associated with the actuator 22 to detect actuator motion. The processing device 74 may then track time and generate a signal when a predefined amount of time has passed.

A second sensor 80 may be used to detect the amount of light present and generate a signal when the light level is below a predefined level. A third sensor 80 may detect the color of a background being used during the testing procedure, and the processing device 74 may generate a signal if the background color is not what is required. The processing device 74 may further be associated with communication circuits 82 that allows the apparatus 10 to communicate with remote devices 84, such as a smartphone, tablet computer, or other computer-based technology.

The electronic module 72 comprises sensors, processors, and remote devices (i.e., smartphones, computers, database servers, cloud memory, etc.). One of ordinary skill in the art will recognize that the inherent flexibility of computer and digital-based systems allows for a great variety of possible configurations, combinations, and divisions of tasks and functionality between and among components. For instance, apparatus 10 may report test results to a local computing device, which then transfers such results to a database using a single server or multiple servers working in combination. Similarly, databases and logic for manipulating the databases may be implemented on a single system or distributed across multiple systems sequentially or in parallel. Data transferred between components may travel directly or indirectly. For example, if a first device accesses a file or data from a second device, the access may involve one or more intermediary devices, proxies, and the like. The actual file or data may move between the components, or one device may provide a pointer or metafile that the other device uses to access the actual data from a still further device.

The electronic module 72 discussed herein is not limited to any particular hardware architecture or configuration. Embodiments of the methods and systems set forth herein may be implemented by one or more general-purpose or customized computing devices adapted in any suitable manner to provide the desired functionality. The device(s) may be adapted to provide additional functionality complementary or unrelated to the present subject matter, as well. For instance, one or more computing devices may be adapted to provide desired functionality by accessing logic or software instructions rendered in a computer-readable form. When software is used, any suitable programming, scripting, or another type of language or combinations of languages may be used to implement the teachings contained herein. However, software need not be used exclusively, or at all. For example, some embodiments of the systems and methods set forth herein may also be implemented by hard-wired logic or other circuitry, including, but not limited to, application-specific circuits. Of course, combinations of computer-executed software and hard-wired logic or other circuitry may be suitable, as well.

Embodiments of the systems and methods disclosed herein may be executed by one or more suitable computing devices. Such system(s) may include one or more computing devices adapted to perform one or more embodiments of the methods disclosed herein. As noted above, such devices may access one or more computer-readable media that embody computer-readable instructions which, when executed by at least one computer, cause the computer(s) to implement one or more embodiments of the methods of the present subject matter. Additionally, or alternatively, the computing device(s) may include circuitry that renders the device(s) operative to implement one or more of the methods of the present subject matter. Furthermore, components of the presently disclosed technology may be implemented using one or more computer-readable media. Any suitable computer-readable medium or media may be used to implement or practice the presently-disclosed subject matter, including, but not limited to, diskettes, drives, and other magnetic-based storage media, optical storage media, including disks (including CD-ROMs, DVD-ROMs, and variants thereof), flash, RAM, ROM, and other memory devices, and the like.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims, or if they include equivalent structural elements with insubstantial differences from the literal language of the claims

What is claimed is:

1. A handheld vial grabber apparatus comprising:
a base having a grabber portion and a handle portion wherein said grabber portion has a grabber portion top surface and an opposing grabber portion bottom surface that extend away from said handle portion to a grabber point and wherein said handle portion extends away from said grabber portion at a predefined handle angle to a handle point;
a plurality of vial ports defined at said grabber point wherein each of said plurality of vial ports is configured to receive at least part of a vial;
a retainer movably associated with said grabber portion wherein said retainer defines a plurality of vial latches and wherein said retainer is disposed adjacent to one of said grabber portion top surface or said grabber portion bottom surface, so that said plurality of vial latches are adjacent to said vial ports; and
an actuator mechanically associated with said retainer and configured to move said retainer to one of an engaged position or a disengaged position.

2. A handheld vial grabber apparatus as in claim 1, wherein said retainer defines a first retainer surface and an opposing second retainer surface and wherein the first retainer surface is disposed adjacent to said grabber portion top surface and the second retainer surface is configured to receive said actuator.

3. A handheld vial grabber apparatus as in claim 2, further comprising bottom plate disposed adjacent to the grabber portion bottom surface and wherein said retainer is movably mechanically associated with said bottom plate.

4. A handheld vial grabber apparatus as in claim 3, further comprising a resilient element defining a resilient element first end and a resilient element second end and wherein said resilient element first end is associated with a bottom plate tab defined by said bottom plate and wherein said resilient element second end is associate with a retainer tab defined by said retainer so that said retainer is biased in the engaged position.

5. A handheld vial grabber apparatus as in claim 4, wherein said grabber portion defines a void configured to receive said resilient element and wherein said resilient element is suitably sized to fit at least partially inside said void.

6. A handheld vial grabber apparatus as in claim 2, wherein said actuator defines two opposing actuator tabs.

7. A handheld vial grabber apparatus as in claim 1, wherein said handle portion defines two opposing risers that extend away from said grabber portion to a gripping element and wherein a grip gap is defined between said two opposing risers and wherein said grip gap is configured to allow a user to grab the gripping element.

8. A handheld vial grabber apparatus as in claim 7, wherein said handle angle is between 80 degrees and 150 degrees.

9. A handheld vial grabber apparatus as in claim 1, wherein said base is at least partially translucent and said retainer defines a plurality of retainer voids.

10. A handheld vial grabber apparatus as in claim 1, further comprising an electronic module comprising:
a processing device;
a memory electrically associated with said processing device for storing a first logic;
at least one sensor electrically associated with said processing device configured for detecting movement of said actuator; and
wherein said processing device is configured to execute said first logic which causes said processing device to generate inspection information.

11. A handheld vial inspection apparatus as in claim 10, wherein said electronic module further comprises communication circuits electrically associated with said processing device configured to communicate with a remote device.

12. A handheld vial grabber apparatus comprising:
a base means for providing a handle at a first end and a grabber point at a second end;
a plurality of vial ports defined at said base means at said grabber point;
a retainer means movably associated with said base means and configured for engaging and retaining vials in said vial ports when placed in an engaged position and disengaging from the vials when placed in a disengaged position;
an actuator means mechanically associated with said retainer means and configured for transitioning said retainer means between the engaged position and the disengaged position.

13. A handheld vial grabber apparatus as in claim 12, further comprising a resilient means for biasing said retainer means in one of the engaged position or the disengaged position.

14. A handheld vial grabber apparatus as in claim 13, wherein said resilient means is a spring.

15. A handheld vial grabber apparatus as in claim 12, wherein said base means has defines a grabber portion and a handle portion wherein the handle portion has two risers that extend away from the grabber portion at a predefined handle angle between about 80 degrees and about 150 degrees.

16. A handheld vial grabber apparatus as in claim 15, wherein said risers extend away from each other at a predefined riser angle to create a predefined riser gap between the risers and wherein said predefined riser angle is between about 35 degrees and about 55 degrees.

17. A handheld vial grabber apparatus as in claim 12, wherein said base means is at least partially translucent and said retainer means defines a plurality of retainer voids for allowing light to shine to and through said base means.

18. A handheld vial inspection apparatus as in claim 12, further comprising an electronic module means for detecting movement of said actuator and communicating with remote devices.

19. A handheld vial grabber apparatus comprising:
a base defining two opposed surfaces that bend to create a horizontal surface and a vertically extending surface;
a plurality of vial ports defined at a free end of said horizontal surface wherein each of said plurality of vial ports is configured to receive at least part of a vial;
a handle defined at the free end of said vertically extending surface;
a retainer movably associated with said base;
a plurality of vial latches defined by said retainer and configured for engaging and retaining vials within said plurality of vial ports when said retainer is moved to an engaged position and wherein said plurality of vial latches are configured to release the vials when the retainer is moved to a disengaged position;
an actuator mechanically associated with said retainer and configured to move said retainer to the engaged position or the disengaged position; and
wherein said handle and said actuator are positioned relative to each other to allow a user to grasp the handle and actuate the actuator using one hand.

20. A handheld vial grabber apparatus as in claim 19, further comprising a resilient element for biasing said retainer in one of the engaged position or the disengaged position.
